(19) United States
(12) Patent Application Publication
(10) Pub. No.: US 2015/0278310 A1
(43) Pub. Date: Oct. 1, 2015

(54) DATABASE DEVICE

(71) Applicant: NEC Corporation, Tokyo (JP)

(72) Inventor: Terumasa KAWABATA, Tokyo (JP)

(21) Appl. No.: 14/666,487

(22) Filed: Mar. 24, 2015

(30) Foreign Application Priority Data
Mar. 26, 2014 (JP) 2014-063526

(51) Int. Cl. G06F 17/30

(52) U.S. Cl. CPC G06F 17/30498; G06F 17/30864

(57) ABSTRACT

A database device includes: a plurality of data processors each of which executes a process of sorting tabular data divided into column forms; a data distributor which distributes records of acquired tabular data to the data processors in accordance with element values contained in the respective records of the tabular data; and a data storage part which joins and stores results of the process executed by the respective data processors. The plurality of data processors execute the sorting process in accordance with the element values contained in the respective records of the tabular data.

### INCORPORATION BY REFERENCE

This application is based upon and claims the benefit of priority from Japanese patent application No. 2014-063526, filed on Mar. 26, 2014, the disclosure of which is incorporated herein in its entirety by reference.

### TECHNICAL FIELD

The present invention relates to a database device, a program, an information processing method, and a database system.

### BACKGROUND ART

There is a known column store database which divides data by column and holds the data. As described above, in a column store database, data is divided by column and held. Therefore, a column store database can fast execute column-oriented processing, for example, processing of values in a specific column at a time.

Thus, a column store database is a database which excels at column-oriented data aggregation, analysis and so on, for example, extracting a column and executing aggregation. Therefore, a column store database is utilized, for example, in a situation where the user wants to fast conduct aggregation or join in execution of batch processing of a large amount of data.

An example of column store databases is a system which sorts and stores data on a column basis and thereby increases the speed of processing such as reference, aggregation or join. Such a system that sorts and stores data needs to sort data in each column every time update enters. Therefore, for example, when a large number of update orders enter, the system needs to execute sort in response to each of the orders. This causes a problem in the system that processing performance deteriorates due to execution of sort in response to each order.

An example of techniques for solving the problem is disclosed in Patent Document 1, for example. According to Patent Document 1, in execution of addition of data, the identification value of a formerly stored data subset is added to the permutation value of data to be added and to the identification value of each symbol value included in a data subset to be added. Moreover, the largest value of the identification values of the symbol values included in the data subset to be added is set to the identification value of the data subset to be added. According to Patent Document 1, data addition by such processing enables faster response to addition without largely impairing fast reading response performance.
Patent Document 1: Japanese Unexamined Patent Application Publication No. JP-A 2011-209807

However, depending on the use of a column store database, there is a case where the user wants to properly sort data and realize fast reference, aggregation and join. In this case, the abovementioned problem of deterioration of processing performance recurs due to sorting in the abovementioned manner.

Further, an example of column store databases executing sort for each column is a system configured to, when a large number of data updates enter, divide update data by the number of cores of a CPU so as to enable parallel processing, and cause each thread to execute sort. In this system, there is a need to, after data processing by the respective threads end, execute processing such as merging the results of the sort executed by the respective threads and organize information of addresses indicating data. Therefore, a wait until processing by the respective threads end occurs, which causes a problem that an effect of parallelization may not be sufficiently produced.

Thus, a column store database has had a problem that it cannot sufficiently deliver its performance when executing data update and so on.

### SUMMARY

Accordingly, an object of the present invention is to provide a database device which solves the problem that it cannot sufficiently deliver its performance when executing data update and so on.

In order to achieve the object, a database device as an aspect of the present invention is a database device including:

a plurality of data processors each of which executes a process of sorting tabular data divided into column forms;

a data distributor which distributes records of acquired tabular data to the data processors in accordance with element values contained in the respective records of the tabular data; and

a data storage part which joins and stores results of the process executed by the respective data processors,

wherein the plurality of data processors execute the sorting process in accordance with the element values contained in the respective records of the tabular data.

Further, a program as another aspect of the present invention is a program including instructions for causing an information processing device to realize:

a plurality of data processors each of which executes a process of sorting tabular data divided into column forms;

a data distributor which distributes records of acquired tabular data to the data processors in accordance with element values contained in the respective records of the tabular data; and

a data storage part which joins and stores results of the process executed by the respective data processors,

wherein the plurality of data processors execute the sorting process in accordance with the element values contained in the respective records of the tabular data.

Further, an information processing method as another aspect of the present invention is an information processing method including:

distributing records of acquired tabular data to a plurality of data processors in accordance with element values contained in the respective records of the tabular data; and

causing each of the data processors to execute a process of sorting tabular data divided into column forms, and joining and storing results of the process executed by the respective data processors.

Further, a database system as another aspect of the present invention is a database system including a database device and a client device,

the database device including: a plurality of data processors each of which executes a process of sorting tabular data divided into column forms; a data distributor which distributes records of acquired tabular data to the data processors in accordance with element values contained in the respective records of the tabular data; and a data storage part which joins and stores results of the process executed by the respective data processors, wherein the plurality of data processors execute the sorting process in accordance with the element values contained in the respective records of the tabular data, and

the client device transmitting the tabular data to the database device.

With the configurations as described above, the present invention can provide a database device which can sufficiently deliver its processing performance even when executing update of a large amount of data, for example.

### BRIEF DESCRIPTION OF DRAWINGS

FIG. 1 is a block diagram showing the configuration of a whole database system according to a first exemplary embodiment of the present invention;

FIG. 2 is a block diagram showing the configuration of a column store database management system according to the first exemplary embodiment of the present invention;

FIG. 3 is a block diagram showing an example of the configuration of a query execution part 33 shown in FIG. 2;

FIG. 4 is a table showing an example of data before update for describing processing by the column store database management system;

FIG. 5 is a table showing an example of columns obtained by conversion of the tabular data shown in FIG. 4;

FIG. 6 is a table showing an example of update data for describing the processing by the column store database management system;

FIG. 7 is a table showing an example of data after update for describing the processing by the column store database management system;

FIG. 8 is a view for describing the overview of the processing by the column store database management system;

FIG. 9 is a view for specifically describing the processing by the column store database management system;

FIG. 10 is a view for specifically describing the processing by the column store database management system;

FIG. 11 is a view for specifically describing the processing by the column store database management system;

FIG. 12 is a view for specifically describing the processing by the column store database management system;

FIG. 13 is a view for specifically describing the processing by the column store database management system;

FIG. 14 is a view for specifically describing the processing by the column store database management system;

FIG. 15 is a flowchart showing an example of the operation of the column store database management system;

FIG. 16 is a flowchart describing the operation of a thread;

FIG. 17 is a flowchart showing an example of the operation of a column store database relating to the present invention;

FIG. 18 is a block diagram showing the configuration of a column store database management system according to a second exemplary embodiment of the present invention;

FIG. 19 is a schematic block diagram showing the overview of the configuration of a database device according to a third exemplary embodiment of the present invention; and

FIG. 20 is a schematic block diagram showing the overview of the configuration of a database system according to a fourth exemplary embodiment of the present invention.

### EXEMPLARY EMBODIMENT

Next, exemplary embodiments of the present invention will be described in detail referring to the attached drawings.

### First Exemplary Embodiment

In a first exemplary embodiment of the present invention, a column store database system 1 which divides tabular data in the column direction and store the data will be described. As described later, the database system 1 in this exemplary embodiment is configured to, when executing a large amount of updates by overnight batch processing or the like, be able to collectively reflect updates within a period designated by the user at a time. Further, the database system 1 in this exemplary embodiment is configured to, when executing data update or the like, be able to execute parallel processing by using a plurality of CPUs. Furthermore, the database system 1 in this exemplary embodiment is configured to, when executing parallel processing by using the plurality of CPUs, be able to cause the respective CPUs to execute highly independent processes, which will be described later.

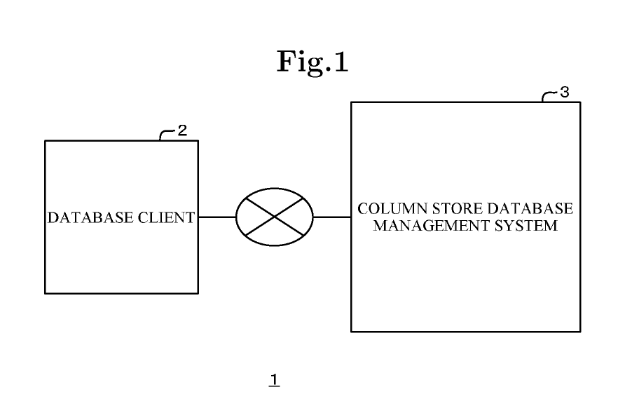

Referring to FIG. 1, the database system 1 in this exemplary embodiment has a database client 2 (a client device) and a column store database management system 3 (a database device). As shown in FIG. 1, the database client 2 and the column store database management system 3 are connected via a network and configured to be able to communicate with each other.

In this exemplary embodiment, a case where the column store database management system 3 includes one information processing device will be described. However, implementation of the present invention is not limited to the abovementioned case. The column store database management system 3 may include a plurality of information processing devices as a distributed database management system does. Moreover, the database client 2 and the column store database management system 3 do not need to be connected via a network necessarily. The database client 2 and the column store database management system 3 may be configured by one information processing device, for example.

The database client 2 is an information processing device. The database client 2 includes a central processing unit (CPU) and a storage device (a memory and a hard disk), which are not shown in the drawings. The database client 2 is configured to realize functions to be described later by execution of a program stored in the storage device by the CPU.

The database client 2 has a function of issuing a query to, for example, insert, update or delete data to the column store database management system 3. Moreover, the database client 2 has a function of accepting the result of the query from the column store database management system 3. Thus, the database client 2 includes general functions for issuing a query to the column store database management system 3.

Further, the database client 2 has a function of notifying, to the column store database management system 3, an update mode start instruction which is an instruction to start an update mode to be described later and an update mode end instruction which is an instruction to end the update mode. As described later, as the database client 2 notifies the update mode start instruction to the column store database management system 3, the column store database management system 3 starts the update mode. Also, as the database client 2 notifies the update mode end instruction to the column store database management system 3, the column store database management system 3 ends the update mode.

The column store database management system 3 is an information processing device. The column store database management system 3 includes a central processing unit (CPU) and a storage device (a memory and a hard disk), which are not shown in the drawings. The column store database management system 3 is configured to realize functions to be described later by execution of a program stored in the storage device by the CPU.

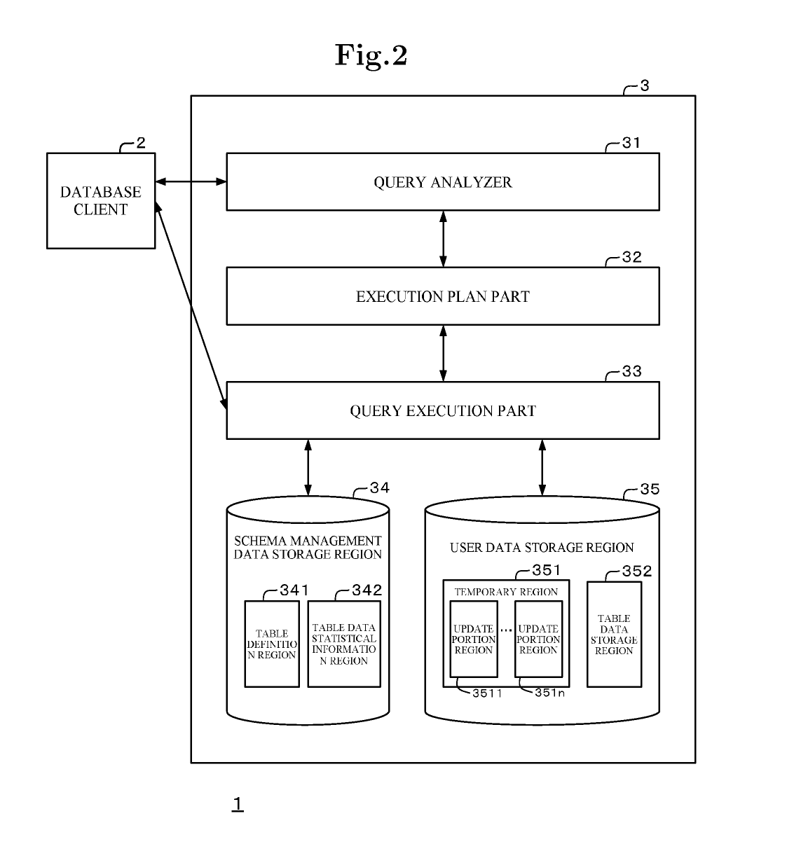

Referring to FIG. 2, the column store database management system 3 has a query analyzer 31, an execution plan part 32, a query execution part 33, a schema management data storage region 34 (part of a data storage part), and a user data storage region 35 (part of the data storage part). Moreover, the schema management data storage region 34 has a table definition region 341 and a table data statistical information region 342. Furthermore, the user data storage region 35 has a temporary region 351 having a plurality of update portion regions 3511 (3511, 3512, . . . , and 351n; hereinafter, when not distinguished, referred to as the update portion region 3511), and a table data storage region 352.

The query analyzer 31 has a function as a parser which checks the content of a query language such as SQL (Structured Query Language) issued by the database client 2 and executes parsing. To be specific, the query analyzer 31 receives a query (an SQL statement) transmitted by the database client 2. Subsequently, the query analyzer 31 executes parsing of the received SQL statement. Then, the query analyzer 31 transmits the result of the parsing to the execution plan part 32.

The execution plan part 32 has a function as a planner which determines the most efficient sequence and method for executing a query analyzed by the query analyzer 31 and creates an execution plan therefor. Upon receiving the result of parsing from the query analyzer 31, the execution plan part 32 creates an execution plan based on the received result. Then, the execution plan part 32 transmits the created execution plan to the query execution part 33.

Meanwhile, when the operation of the query execution part 33 is directly designated from the database client 2 by using API (Application Programming Interface), either the query analyzer 31 or the execution plan part 32 is not passed through.

The query execution part 33 has a function of executing a data operation order in accordance with an execution plan created by the execution plan part 32. Moreover, the query execution part 33 has a function of, in response to a data operation order directly received from the database client 2 (for example, a data operation order written by using the API), executing a query on the schema management data storage region 34 and the user data storage region 35. Thus, the query execution part 33 is equivalent to a portion which is a so-called executor of a database.

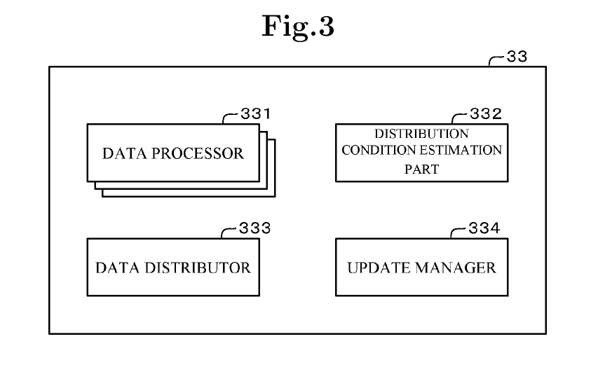

FIG. 3 is an example of the function of the query execution part 33. Referring to FIG. 3, the query execution part 33 has a data processor 331, a distribution condition estimation part 332, a data distributor 333, and an update manager 334.

The data processor 331 has a function of executing data processing such as execution of a query. The column store database management system 3 in this exemplary embodiment has a plurality of CPU cores and is configured to be able to execute a plurality of threads by using the plurality of CPU cores. In other words, the data processor 331 is configured to be able to execute parallel processing by using the plurality of CPU cores as the plurality of CPU cores execute processing, respectively. Hereinafter, a case where the column store database management system 3 includes four CPU cores will be described as one example. However, the column store database management system 3 may include two or three CPU cores, or may include five or more CPU cores.

The distribution condition estimation part 332 has a function of estimating the distribution condition of element values contained in the respective records of tabular data (update data) which is the target of a given process (a query) such as update, from statistical information to be described later stored in the table data statistical information region 342 and sorted data stored in the table data storage region 352. An element value in this exemplary embodiment is a value which does not include information for identifying each record and which is the target of a given process such as update. For example, the distribution condition estimation part 332 acquires a histogram (statistical information) of values which are the target of a query, from the table data statistical information region 342. Then, the distribution condition estimation part 332 uses the acquired histogram to estimate the data distribution of update data. After that, the distribution condition estimation part 332 transmits the result of the estimation to the data distributor 333. The data distribution estimation part 332 operates in the update mode to be described later.

The data distributor 333 has a function of, based on the result of estimation by the distribution condition estimation part 332, distributing update data (the respective records of tabular data) so that the numbers of the update data to be processed by the respective CPU cores are uniform. For example, based on the result of estimation by the distribution condition estimation part 332, the data distributor 333 sets a partition rule for dividing data by the number of parallel processing into ranges supposed to make the numbers of update data of the respective CPU cores uniform. In other words, based on the result of estimation by the distribution condition estimation part 332, the data distributor 333 sets a transmission destination threshold (a distribution threshold) to change the transmission destination of update data. Then, based on the set transmission destination threshold, the data distributor 333 stores the update data into the same number of update portion regions 3511 as the number of parallel processing (the number of the CPU cores), which will be described later. Consequently, the data distributor 333 distributes the update data so that, for example, records containing close element values are processed by the same data processor 331 as described later. Thus, the data distributor 333 has a function of distributing update data to the respective update portion regions 3511 based on the distribution condition of the element values of the update data. Moreover, through the distribution by the data distributor 333, the update data are uniformly distributed to the respective update portion regions 3511 secured by the number of the CPU cores. The data distributor 333 operates in the update mode to be described later.

The update manager 334 has a function of managing when to start and when to end the update mode. In other words, the update manager 334 performs management whether to execute update utilizing the update mode or execute normal update. As described above, when start of the update mode is notified by the database client 2, the update manager 334 starts the update mode. When the update mode starts, update data acquired from then on are to be distributed to the respective update portion regions 3511 by the data distributor 333. Then, the distributed update data are pooled in the respective update portion regions 3511 until the update mode ends. When end of the update mode is notified by the database client 2, the update manager 334 ends the update mode. When the update mode ends, processing on the update data stored in the update portion regions 3511 is started by the data processor 331. The details of the processing on the update data will be described later.

The schema management data storage region 34 is a storage device such as a memory or a hard disk. The schema management data storage region 34 stores and manages schema definition information of the database. As mentioned above, the schema management data storage region 34 has the table definition region 341 and the table data statistical information region 342.

The table definition region 341 stores information, such as definition information of tables, indexes and so on and information of devices and positions therein where the data are stored, which are held in a general relational database. In other words, the table definition region 341 stores information which is generally called a system table or a system catalog.

The table data statistical information region 342 stores statistical information about table data of the user. In other words, the table data statistical information region 342 stores the same information as statistical information that is utilized for creating a cost-based execution plan in response to an SQL query in a general relational database.

The user data storage region 35 is a storage device such as a memory or a hard disk. The user data storage region 35 stores data such as data of the database and temporary data generated in execution of data processing. As mentioned above, the user data storage region 35 has the temporary region 351 including the plurality of update portion regions 3511, and the table data storage region 352.

The temporary region 351 stores intermediate data issued by a database query, and so on. Further, as mentioned above, the temporary region 351 has the update portion regions 3511. The same number of update portion regions 3511 as the number of the CPUs installed in the column store database management system 3 are secured in the temporary region 351.

The update portion region 3511 is a region to store data to be processed by one core during data update utilizing the update mode. Therefore, as mentioned above, the corresponding number of update portion regions 3511 to the number of the CPU cores are generated. In other words, the update portion regions 3511 are generated in accordance with the number of threads to be described later. When the update mode starts, update data are distributed by the data distributor 333 to the update portion regions 3511. When the update mode ends, processing by the data processor 331 (the CPU cores) is executed by using the update data stored in the update portion regions 3511.

The table data storage region 352 stores actual data, index data and so on of the database based on the definition stored in the table definition region 341.

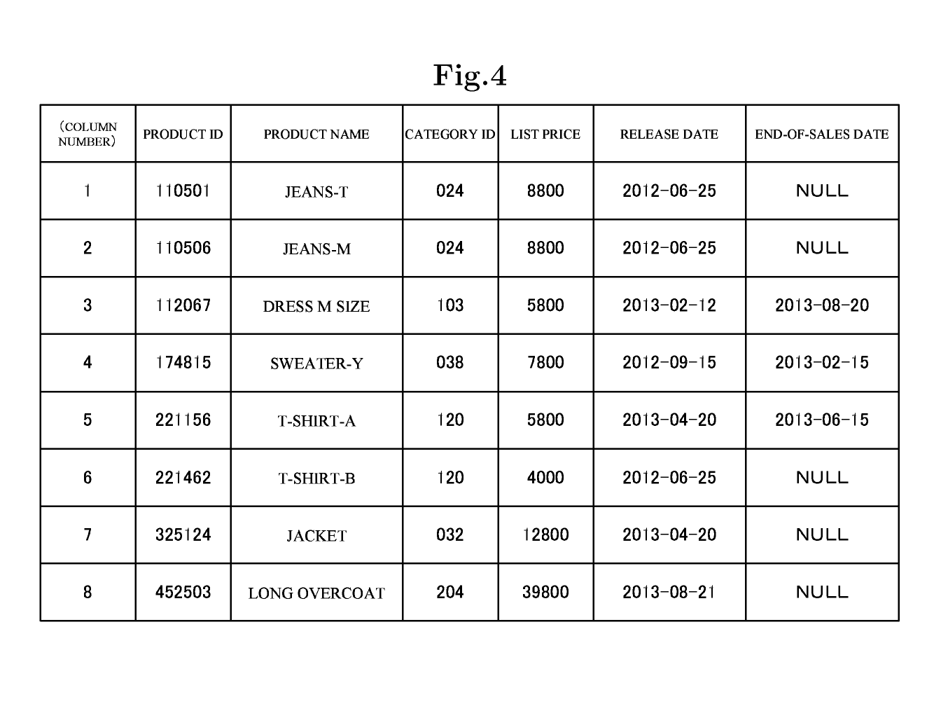

That is the configuration of the database system 1 in this exemplary embodiment. Herein, specifically defining a table “product table” shown in FIG. 4, the details of processing executed by the column store database management system 3 will be described. The product table shown below is an example of a table that can be processed by the database system 1.

Referring to FIG. 4, it is assumed that the product table includes, for example, a “product ID” column, a “product name” column, a “category ID” column, a “list price” column, a “release date” column, and an “end-of-sales date” column.

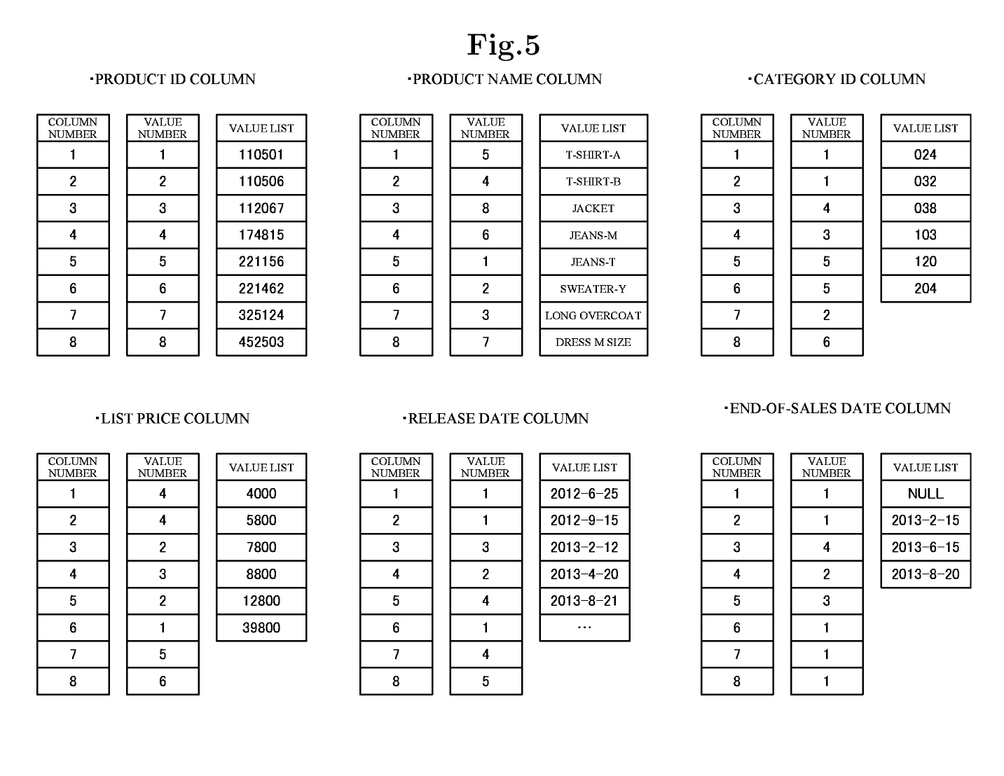

When such a product table is loaded to a column store database system (e.g., the column store database management system 3), the inner structure thereof is as shown in FIG. 5, for example. Referring to FIG. 5, it is found that, in the column store database management system 3, the inner structure has Column Number, Value Number and Value List for each of the columns of the table (tabular data).

Column Number shows what row each data in the column is in. In Value Number, an index number for Value List is written. In Value List, duplication of actual data is eliminated and the data are arranged in the sorted form. With this configuration, the column store database management system 3 stores a logical product table. In FIG. 5, a column number and a value number located in the same positions are a column number and a value number corresponding to each other (for example, in the product Name column, “2” located in the second row from the top in Column Number corresponds to “4” located in the second row from the top in Value Number).

For example, when a list price in the second row of the product table is referred to in the structure of the column store database shown in FIG. 5, a number “4,” which is located in the second row in Value Number and located in the same position as a column number “2” in the list price column of the product table, is acquired (see FIG. 5). Then, based on the acquired number “4,” a value in the fourth row in Value List of the list price column is checked. Thus, it is found the value is “8800.”

In such a model of a column store database in which data is sorted and stored, it is possible to, in data retrieval and so on, utilize binary search without converting data. Moreover, it is possible to join only by comparing value lists sorted with respect to columns to be joined, and examining the relation between value list numbers thereof. Therefore, in such a model of a column store database in which data is sorted and stored, it is possible to execute fast processing for aggregation and retrieval. Hereinafter, such a model of a column store database is described as a FAST structure.

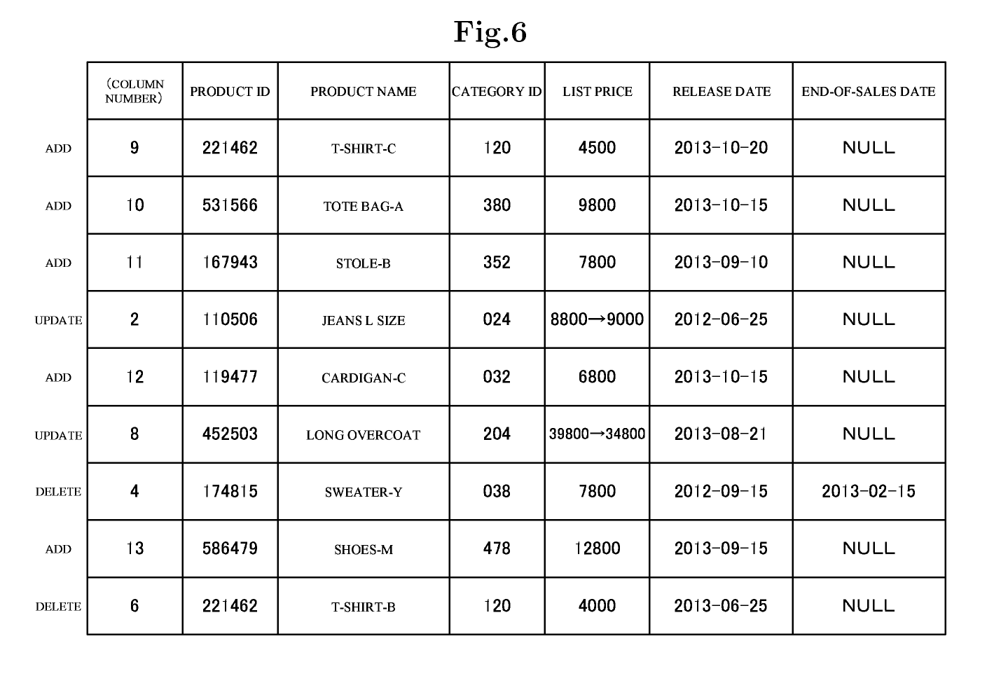

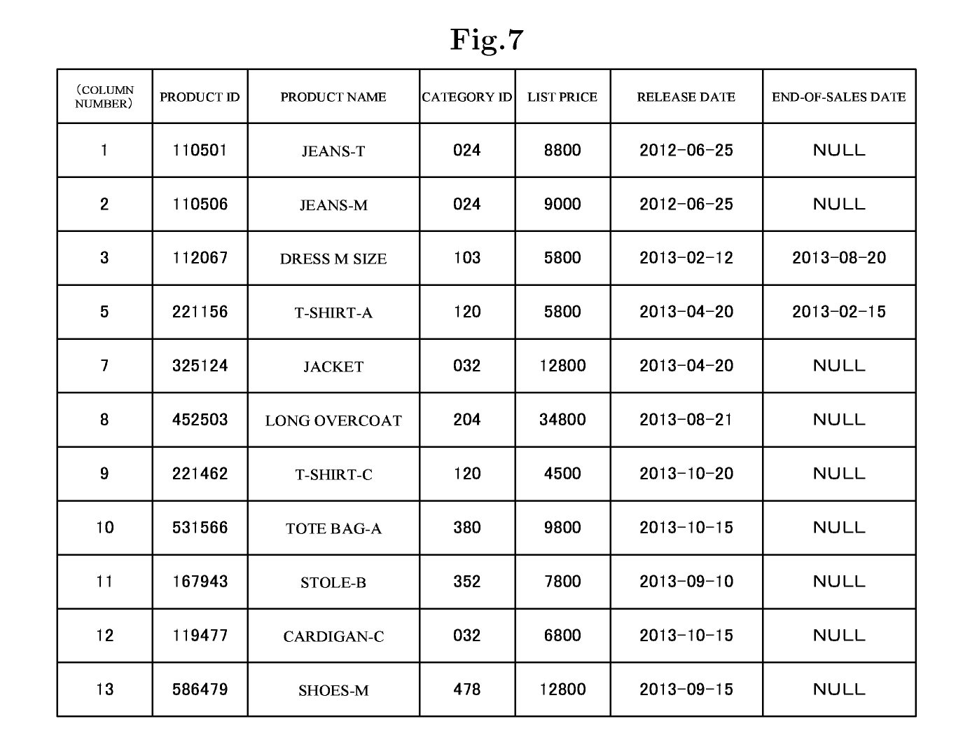

A case of updating the product table shown in FIG. 4 with data shown in FIG. 6 by utilizing the update mode will be considered. In FIG. 6, a new column number is applied in the case of INSERT, whereas the column number of a processing target is written in the case of UPDATE and DELETE. In the case of UPDATE, how a list price changes is written, for example. When a plurality of update orders are made for the same column during the update mode, only a final update result is stored in the table shown in FIG. 6. Moreover, when the update data shown in FIG. 6 is reflected on the product table shown in FIG. 4, the result is as shown in FIG. 7.

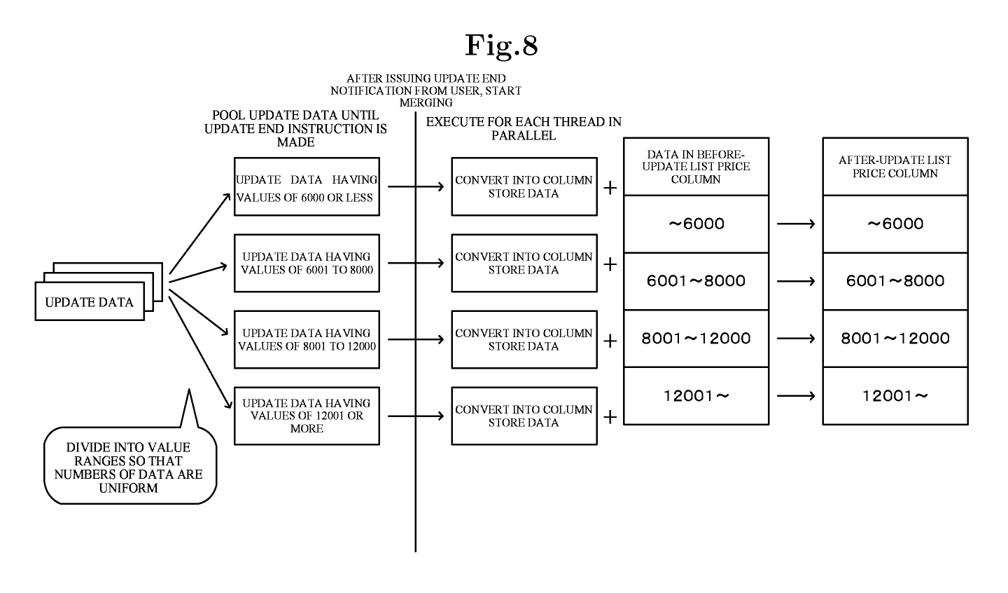

First, parallel execution of update of the FAST structure of each column by the column store database management system in this exemplary embodiment will be briefly described referring to FIG. 8.

Because the system is a column store type, update is executed on a column basis. Therefore, as one example of update executed on a column basis, update of the list price column of the product table will be described below (update is executed on the other columns in the same manner). Further, as mentioned above, the column store database management system 3 in this exemplary embodiment includes the four CPU cores. Therefore, four processes are executed in parallel.

Referring to FIG. 8, when the update manager 334 shifts to the update mode, update data acquired from then on are distributed to the respective update portion regions 3511 by the data distributor 333. The distribution is performed in accordance with a distribution condition estimated by the distribution condition estimation part 332.

For example, referring to FIG. 8, based on an update data distribution condition estimated from a histogram of the list price column stored in the table data statistical information region 342, the data distributor 333 distributes update data to four; “6000 or less,” “6001 to 8000,” “8001 to 12000,” and “12001 or more.” In other words, the data distributor 333 distributes update data so that update data including close values are processed by the same data processor 331, based on the distribution condition of the update data. Then, the distributed update data are pooled in the respective update portion regions 3511 (for example, the update portion regions 3511 to 3514) until the update mode ends.

After that, when the update mode ends, the update data pooled in the respective portion regions 3511 are converted into column store data (a FAST structure). Then, the update data converted into the FAST structure is merged with data in Before-Update List Price Column located in a range of values in List Price Column corresponding to the update data (see FIG. 4). After that, the results of processing by the respective threads are joined.

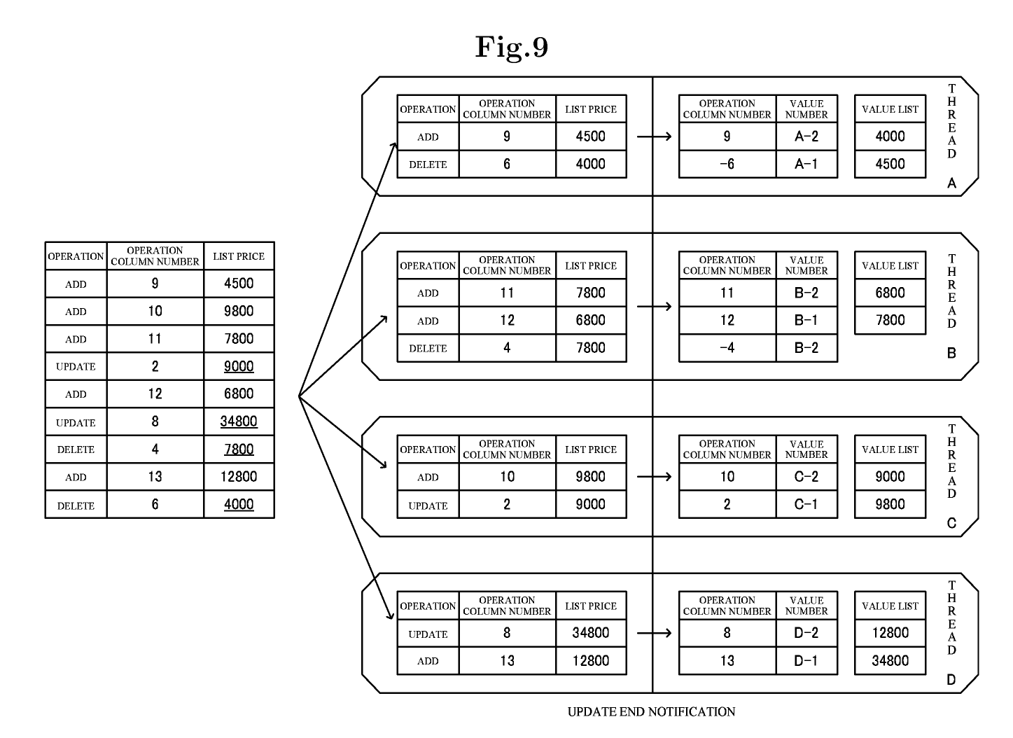

That is the brief description of parallel execution of update of the FAST structure of each column by the column store database management system 3. Next, the processing executed by the column store database management system 3 will be described in specific. Referring to FIG. 9, firstly, during the update mode, a record having a list price value of 4000 and a record having a list price value of 4500, both the records having values of “6000 or less” in List Price Column, are distributed to a thread A (for example, to the update portion region 3511 corresponding to the thread A). Moreover, two records having list price values of 7800 and one record having a list price value of 6800, all the records having values of “6001 to 8000” in List Price Column, are distributed to a thread B (for example, to the update portion region 3512 corresponding to the thread B). Likewise, a record having a list price value of 9800 and a record having a list price value of 9000, both the records having values of “8001 to 12000” in List Price Column, are distributed to a thread C (for example, to the update portion region 3513 corresponding to the thread C). Then, a record having a list price value of 34800 and a record having a list price value of 12800, both the records having values of “12001 or more” in List Price Column, are distributed to a thread D (for example, to the update portion region 3514 corresponding to the thread D).

The update data are pooled in the respective update portion regions (3511 to 3514) until the update mode ends.

After that, when the update mode ends, the system enters a phase to execute update on the actual table data storage region 352. Firstly, the data processor 331 of the query execution part 33 secures the same number of regions to store column numbers and value lists as the number of newly created records in the table data storage region 352. To be specific, the data processor 331 secures the same number of data regions as the maximum number of logical operation column numbers (in this case, 13). Likewise, the data processor 331 secures, in the temporary region 351, regions for a group value list number table and a value number regulation value table as temporary data regions for managing data of values lists of the respective threads. A group value list number table and a value number regulation value table will be described in detail later.

Next, the data processor 331 enters parallel processing for generating final update data. As shown in FIG. 9, the data processor 331 (one of the CPU cores; the thread A) converts the update data stored in the update portion region 3511 into the FAST structure and stores the result into the update portion region 3511. Likewise, the threads B, C and D convert the update data stored in the update portion regions (3512 to 3514) corresponding to the respective threads into the FAST structures, and store the results into the corresponding update portion regions (3512 to 3514). In FIG. 9, an operation column number when deletion is performed is written by using a number with a minus sign. Further, in FIG. 9, a value number is written by using a thread which is to execute processing and a value number in the thread. For example, a value number “A-2” of the ninth operation row shown in FIG. 9 represents that the second in a value list of the thread A is the value.

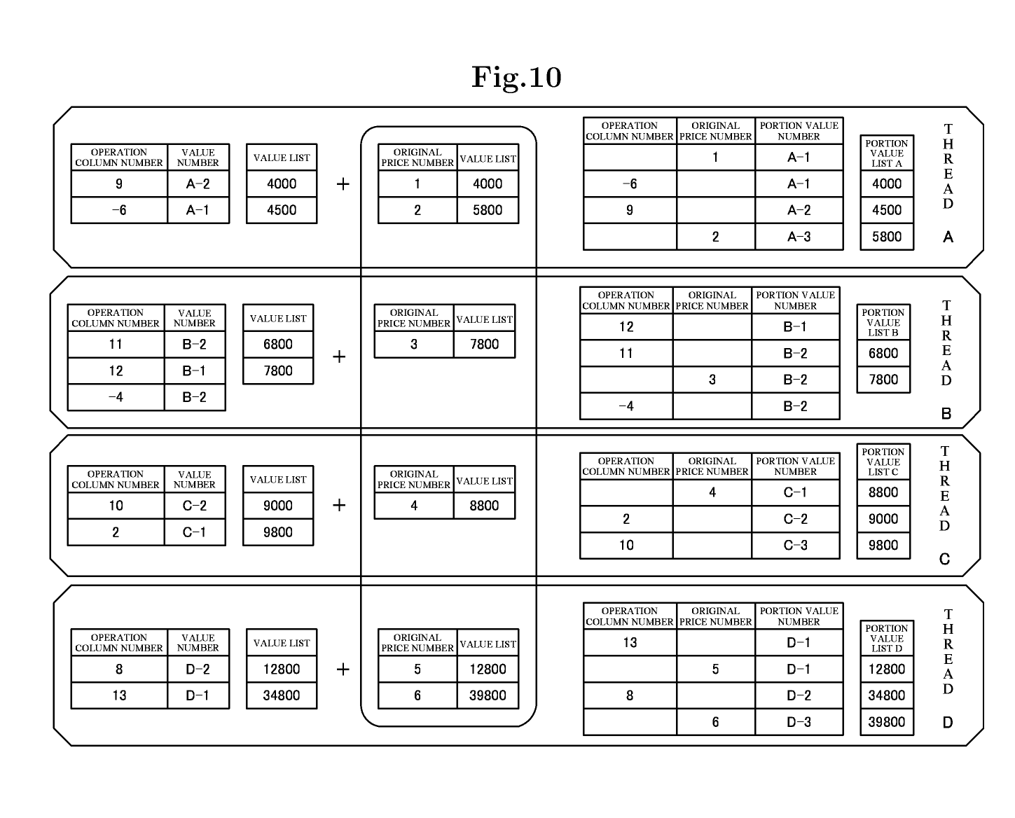

Next, as shown in FIG. 10, each thread merges the FAST structure of update data with the FAST structure of the existing table data (see List Price Column in FIG. 5). In the merging, the existing table data are distributed so as to be in the same data ranges as the update data. In other words, the existing table data are merged after being distributed to “6000 or less,” “6001 to 8000,” “8001 to 12000” and “12001 or more” in accordance with the values in Value List.

To be specific, each thread firstly merges Value List of the FAST structure of the update data with Value List of the existing table data by using merge sort. Subsequently, with respect to the update data, each thread copies operation column numbers before the merging into appropriate sites in Operation Column Number after the merging. Likewise, each thread copies original price numbers before the merging into appropriate sites of Original Price Number after the merging. Through this processing, data as shown in FIG. 10 is generated. This data is fundamental data for executing update of a target range.

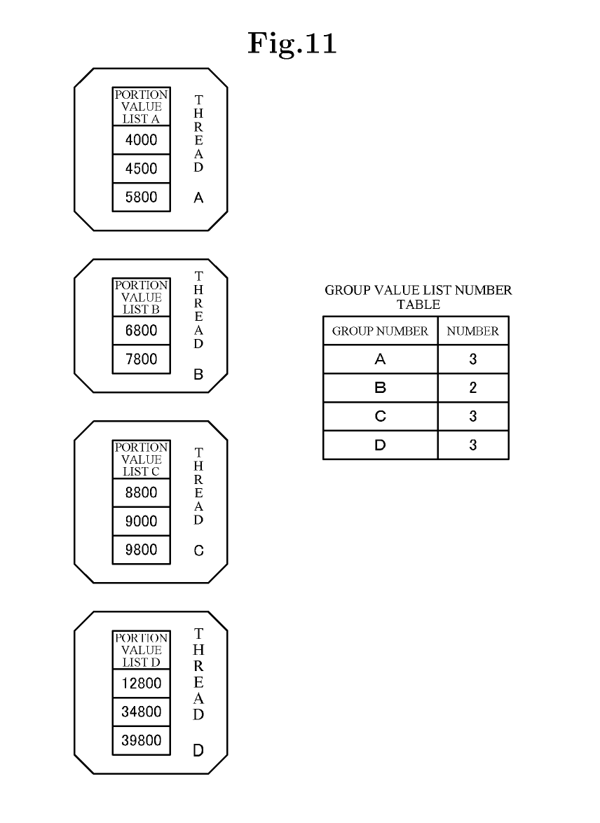

When the merging of the FAST structures, namely, the merging of portion value lists is completed, each thread writes the number of partial values into a group value list number table (secured in the temporary region 351 as mentioned above) as shown in FIG. 11. This process is executed by each thread. In other words, a thread which has finished merging of portion value lists writes the number of partial values into the group value list number table without waiting until the other threads end. This table is to be used for generating final Value Number.

For example, the number of portion values as a result of the merging by the thread A is three. Therefore, the thread A writes “3” into a site for a group number A in the group value list number table. The threads B, C and D perform the same operation.

Next, the thread having written the number of partial portions into the group value list number table executes, based on Operation Column Number and Original Price Number of the completed merging result and List Price Column Before Update, a process of filling appropriate sites of New Value Number (a region to store new value numbers is previously secured in the table data storage region 352 as mentioned above). This process is also executed by each thread. Hereinafter, a case where the thread A firstly executes the process of filling New Value Number will be described as one example.

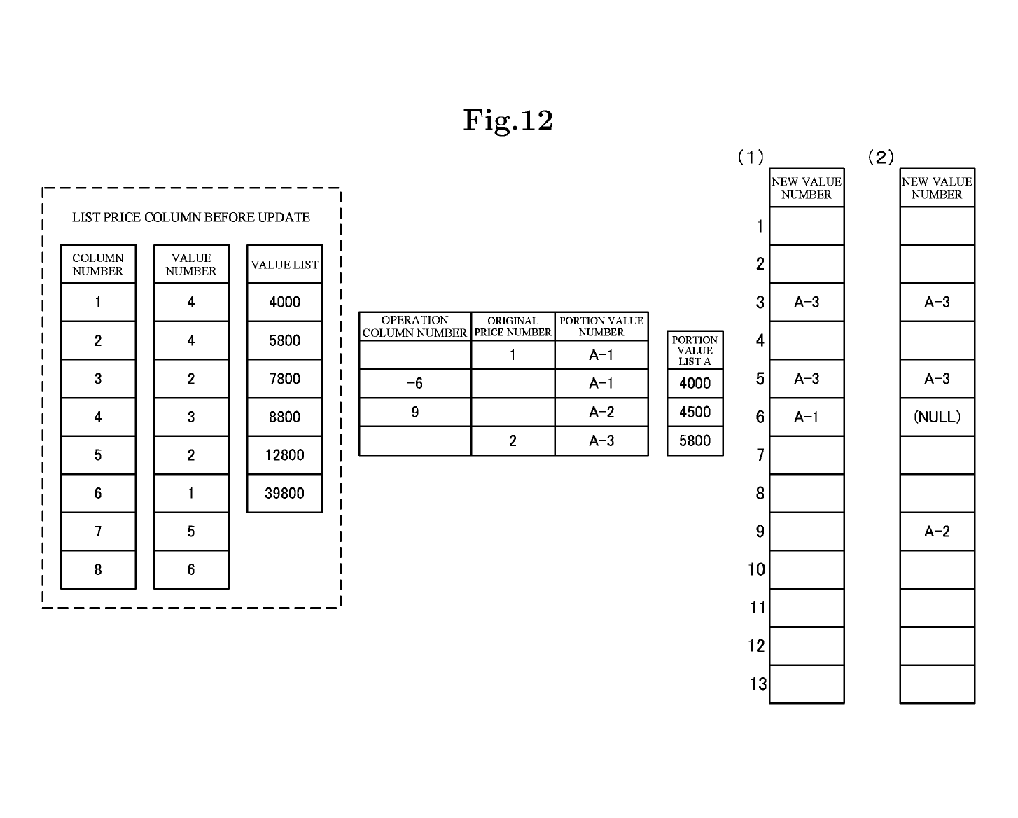

Referring to FIG. 12, the tread A firstly executes a process of associating original price numbers with new value numbers to be newly written in. In FIG. 12, an original price value 1, namely, a value number 1 in List Price Column Before Update corresponds to the column number 6. Therefore, as shown in FIG. 12A, the thread A writes a partial value number A-1 of the original price value 1 as the sixth value in New Value Number. Likewise, an original price number 2, namely, a value number 2 in List Price Column Before Update corresponds to column numbers 3 and 5. Therefore, the thread A writes a partial value number A-3 of the original price number 2 as the third and fifth values in New Value Number.

Next, the thread A executes processing on a row whose data is in Operation Column Number. Referring to FIG. 12, “−6” is written as an operation column number. As described above, a minus sign given to an operation column number represents deletion. Therefore, as shown in FIG. 12B, the thread A deletes the sixth value in New Value Number (changes the value to (NULL)). Moreover, “9” is written as an operation column number. Therefore, the thread A writes a partial value number A-2 of the original price number 9 as the ninth value in New Value Number. In other words, the thread A adds A-2 as the ninth value in New Value Number.

The threads B, C and D also execute the same processing. In other words, each thread executes processing based on operation column numbers after executing processing based on original price numbers. FIG. 12 shows an imaginary view of a case where the thread A enters the process of filling New Value Number earlier than the other threads. However, for example, the thread B may enter the abovementioned process earlier than the thread A. In this case, the thread A executes the abovementioned process on data that the thread B has already executed the process.

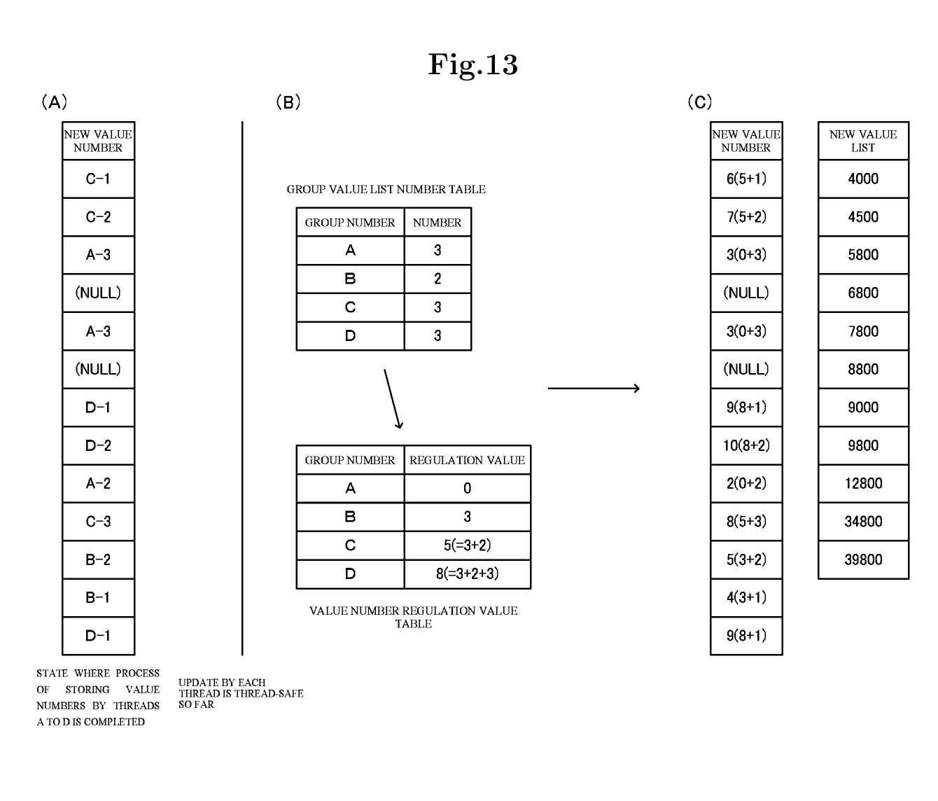

Each thread executes this processing. As a result, all sites of New Value Number are filled in as shown in FIG. 13A.

Because each thread thus fills New Value Number, there is a case where a thread has already filled in a site of a new value number before another thread intends to fill in the site of the new value number. For example, the abovementioned case arises, for example, when the processing on an original value number and the processing on an operation column number are executed by different threads, such as when a change in value is large between before update and after update. In this case, the processing on an original value number or the processing on an operation column number is executed first depending on processing of the threads executing the respective processing. Therefore, in this case, a thread executes processing so as to write over when deleting or updating a record with an operation column number and not to write over when copying from a record with an original price number. By thus preferentially processing data to be updated, it is possible to secure consistency.

Thus, during a period from division of update data and start of processing in parallel to creation of New Value Number, each thread can execute processing without depending on the other threads. In other words, it is absolutely thread-safe so far.

Next, each thread executes a process of converting new value numbers written in group numbers (data written in partial value numbers) into value numbers written in only numbers (final value numbers).

To be specific, each thread firstly creates a value number regulation value table from the group value list number table. Referring to FIG. 13B, in the example shown in this exemplary embodiment, three values exist in the value list in the thread A of the update portion region 3511. Likewise, two values exist in the thread B, three values exist in the thread C, and three values exist in the thread D. Then, each thread calculates a regulation value based on the abovementioned number of values. For example, because portions updated by the thread A are located first in New Value List, the thread A obtains a regulation value 0. Moreover, because portions updated by the thread B are located next to the portions updated by the thread A, the thread B obtains a regulation value 3, which is the number of the values in the value list of the thread A. Likewise, the thread C obtains a regulation value 5, which is the sum of the numbers of the values in the value lists of the threads A and B. Then, the thread D obtains a regulation value 8, which is the sum of the numbers of the values in the value lists of the threads A, B and C.

Subsequently, each thread updates the new value numbers calculated by the thread, by using the obtained regulation value. In other words, each thread adds a value in the value list in the thread to the obtained regulation value, thereby calculating a new value number and converting. For example, with respect to a new value number C-1, the thread C adds the regulation value 5 to the value 1 in the value list, thereby obtaining 6. Consequently, the new value number C-1 is converted into the new value number 6. Through execution of this processing by each thread, new value numbers written in group numbers are converted into value numbers written in only numbers as shown in FIG. 13C.

This processing is executed based on the values in the group value list number table as described above. Therefore, this processing can also be executed in a state which is not as shown in FIG. 13A, that is, even if all the threads have not filled in the new value numbers. For example, even if the thread B is filling in the new value numbers, the thread A having filled in the new value numbers can execute the abovementioned conversion process if all the values in the group value list number table are filled in. Thus, if the process of writing the number of portion values in the group value list number table, which is a process executed before writing new value numbers, has been completed, each thread can enter the conversion process without waiting until the other threads complete the process of writing new value numbers. In other words, this processing does not need to wait strictly until the respective threads simultaneously complete the processing, though it is not absolutely thread-safe.

Further, after completion of the processing by the respective threads, it is possible to create a new value list shown in FIG. 13C by joining the portion value lists created by the respective threads in sequence longitudinally.

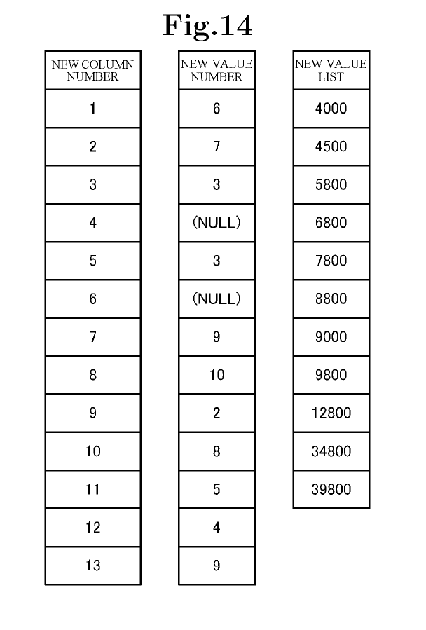

As a result of this processing, the final update result shown in FIG. 14 is stored into the table data storage region 352.

In this exemplary embodiment, for ease of management of transaction, it is assumed that only the final update result is stored in the table shown in FIG. 6. However, the present invention may be implemented, not limited to the abovementioned case. In other words, update data may include a plurality of updates for the same column.

However, in this case, it is assumed that identifiers or the like indicating the sequence of processing of update data are adopted as in methods employed in normal databases. Adoption of identifiers or the like indicating the sequence of the processing makes it possible to execute the processing so as to leave only new data (the last updated data) at the time of storing an update portion column having been converted into the FAST structure into the table data storage region 352. Because this procedure is the same as in general transaction, a detailed description thereof will be omitted.

That is the description of the details of the configuration of the database system 1 and the processing executed by the column store database management system 3 in this exemplary embodiment. Next, the operation of the column store database management system 3 will be described. Firstly, the operation in the update mode of the column store database management system 3 will be described.

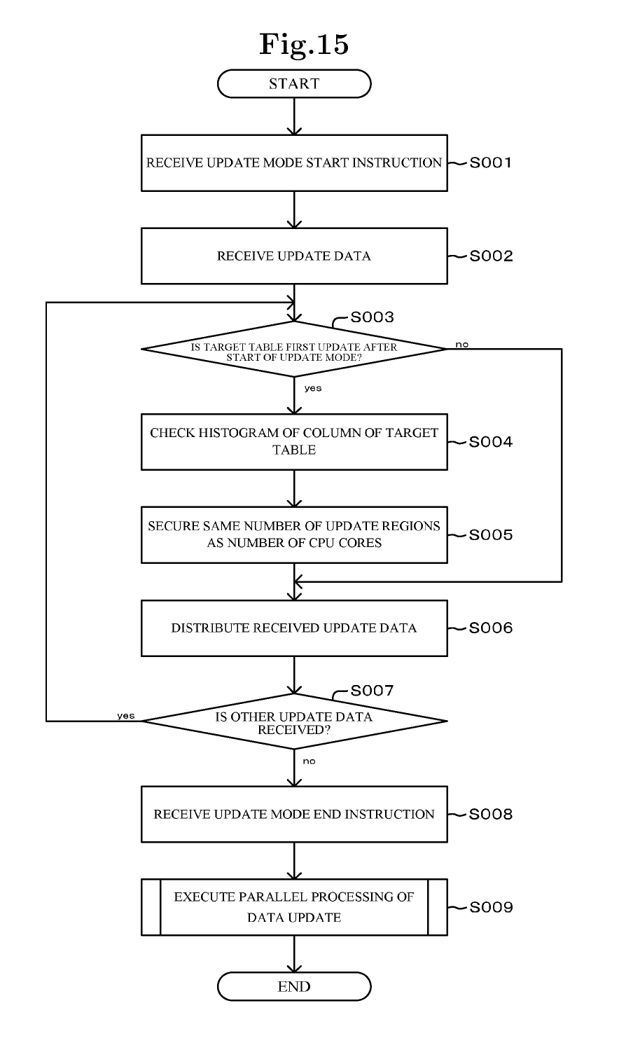

Referring to FIG. 15, the column store database management system 3 receives an update mode start instruction transmitted by the database client 2 (S001). Consequently, the update manager 334 determines to start the update mode.

When the update mode is started, update data acquired from then on are distributed to the respective update portion regions 3511 by the data distributor 333. In other words, when update data is received during the update mode (S002), firstly, the query execution part 33 checks whether or not a target table of the received update data is the first update after the update mode is started (S003). In a case where the first update (S003, yes), the distribution condition estimation part 332 of the query execution part 33 checks the table data statistical information region 342, and checks the histogram of the column of the target table (S004). Moreover, the data processor 331 secures the same number of update portion regions 3511 as the number of the CPU cores (S005). Then, the update data are distributed to the respective update portion regions 3511 by the data distributor 62 (S006).

On the other hand, in a case where the target table of the update data is not the first update after the update mode is started (S003, no), check of the histogram and check of the update portion region 3511 have already been finished. Therefore, the process of distribution of the update data to the respective update portion regions 3511 by the data distributor 62 is executed (S006).

The update data distributed to the respective update portion regions 3511 by the data distributor 62 are pooled in the respective update portion regions 3511 until the update mode is ended.

This distribution process is executed every time update data is received during the update mode (S007).

After that, the column store database management system 3 receives an update mode end instruction transmitted by the database client 2 (S008). Consequently, the update manager 334 determines to end the update mode.

When the update mode is ended, a process by the data processor 331 of updating the update data stored in the update portion regions 3511 is started (S009). In other words, the data processor 331 firstly secures a region to store the same number of column numbers and value lists as the number of newly created records in the table data storage region 352. Likewise, the data processor 331 secures a region for a group value list number table and a value number regulation value table, which are temporary data regions for managing data in value lists of the respective threads, in the temporary region 351. Then, the data processor 331 enters parallel processing for generating final update data. As a result of the parallel processing, the update data are reflected.

That is the description of the operation in the update mode of the column store database management system 3. Next, the operation in an update executed after the update mode ends will be described. The update is executed in parallel. Therefore, of the parallel processing, the operation of one thread (CPU core of the data processor 331) will be described below.

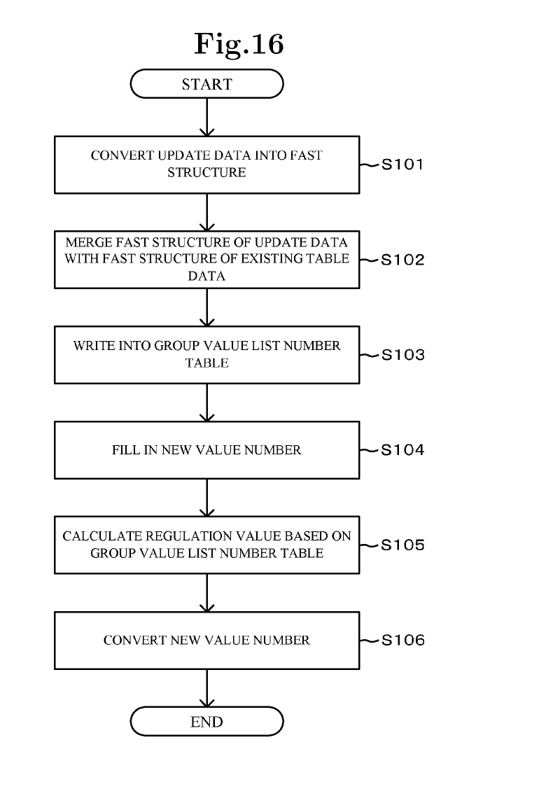

Referring to FIG. 16, as the update mode ends, the thread converts the update data stored in the corresponding update portion region 3511 into the FAST structure (S101). Then, the thread stores the FAST structure obtained by the conversion into the update portion region 3511.

Subsequently, the thread merges the FAST structure of the converted update data with the FAST structure of the existing table data (S102). To be specific, the thread firstly merges the value list of the FAST structure of the update data with the value list of the existing table data by using merge sort. Subsequently, with respect to the update data, the thread copies an operation column number before the merging into an appropriate site for an operation column number after the merging. Likewise, the thread copies an original price number before merging into an appropriate site for an original price number after merging. The thread thus merges the FAST structure of the update data with the FAST structure of the existing table data.

Next, the thread writes the number of portion values generated as a result of merging the FAST structure of the update data with the FAST structure of the existing table data, into a group value list number table (S103). As described above, the group value list number table is secured in the temporary region 351.

Then, based on Operation Column Number and Original Price Number of the merging result and List Price Column Before Update, the thread executes a processing of filling in a corresponding new value number. In other words: the thread acquires Operation Column Number and Original Price Number of the merging result by merging the FAST structure of the update data with the FAST structure of the existing table data; moreover, the thread acquires List Price Column Before Update from the table data storage region 352; and then, based on Operation Column Number and Original Price Number of the merging result and List Price Column Before Update, the thread fills in the corresponding new value number region secured in the table data storage region 352. Herein, a new value number corresponds to the portion value of the merging result.

Regarding the operation so far, the thread can execute processing without depending on the processing by the other threads. In other words, the processing so far is thread-safe.

Next, the thread calculates a regulation value based on the group value list number table, and writes the calculated regulation value into the value number regulation value table (S105). Then, the thread converts the new value number filled in at the step S104 by using the calculated regulation value (S106). In other words, the thread converts the new value number corresponding to the portion value into a new value number corresponding to a final new value list.

That is the operation of the thread. Then, by execution of the abovementioned processing by all the threads executing parallel processing, all new value numbers are written in the table data storage region 352. Further, after completion of the processing by the respective threads, by joining the portion value lists generated by the respective threads in sequence longitudinally, it is possible to create a new value list. Consequently, reflection of the update data ends.

Thus, the column store database management system 3 in this exemplary embodiment includes the update manager 334 and the update portion regions 3511. With such a configuration, the column store database management system 3 can start the update mode in response to an update mode start instruction by the database client 2. Then, the column store database management system 3 can store update data acquired during the update mode into the update portion regions 3511. Further, the column store database management system 3 can end the update mode in response to an update mode end instruction by the database client 2. Then, the column store database management system 3 can process the update data stored in the update portion regions 3511 at a time. In other words, the column store database management system 3 can merge update data acquired during the update mode at a time. As a result, in a case where a large amount of update data enter in overnight batch processing or the like, it is possible to prevent inefficient processing which occurs because merging is executed every time update data enters.

Further, the column store database management system 3 in this exemplary embodiment has the data processor 331 including the plurality of CPU cores, the distribution condition estimation part 332, the data distributor 333, and the update portion regions 3511. With such a configuration, the update data distributor 333 can distribute update data acquired during the update mode to the update portion regions 3511 based on the result of estimation by the distribution condition estimation part 332. In other words, depending on the distribution condition of element values of the update data, the update data distributor 333 distributes the update data so that the numbers of the update data of the respective CPU cores become uniform. As a result, the CPU cores of the data processor 331 can execute highly independent updates based on the update data stored in the update portion regions 3511. Consequently, the CPU core can proceed processing without waiting for processing by the other CPU cores and can execute an update arithmetic process while keeping as thread-safe as possible.

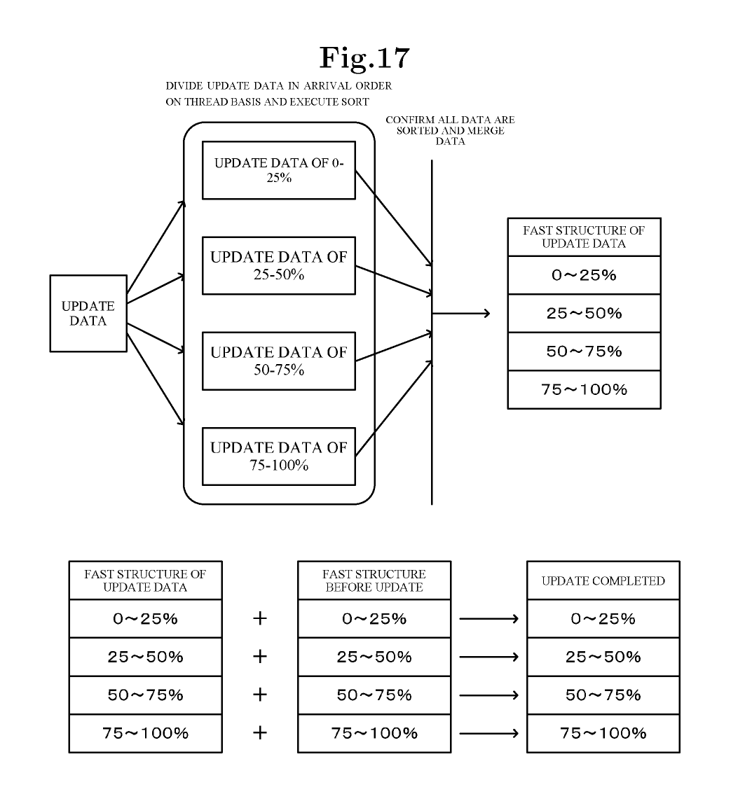

Herein, update executed in a column store database relating to the present invention will be schematically described. Referring to FIG. 17, the column store database relating to the present invention firstly divides update data by the number of the data so as to execute parallel processing in the arrival order. Then, the column store database makes each thread convert each of the divided update data into a FAST structure and creates a FAST structure sorted by the update data. After that, the column store database merges the FAST structures created by the respective threads and completes conversion into the FAST structures with respect to all of the update data. In this processing, the column store database needs to wait until the respective threads complete. In other words, this processing is not thread-safe. By merging the FAST structure of the update data with the FAST structure of the data before update, the update of the column is completed. This merging process further causes a wait.

Thus, the column store database relating to the present invention causes a wait for completion of processing by other threads a plurality of times, and it is apparent that a plurality of CPU cores cannot be sufficiently utilized in total. On the other hand, the present invention enables more utilization of a plurality of cores with the abovementioned configuration.

The present invention is particularly advantageous for creating a data mart from a large number of databases or, specifically, collectively executing update such as replacement of a large amount of data by overnight batch processing on a column store database used in the field of data warehouse or the like. It is needless to say, however, implementation of the present invention is not limited to the abovementioned cases. The present invention can be adapted to general column store databases.

Further, in this exemplary embodiment, the column store database management system 3 starts and ends the update mode in response to instructions by the database client 2. However, implementation of the present invention is not limited to the abovementioned case. The column store database management system 3 may be configured to, for example, by referring to a clock part which is not shown in the drawings, start the update mode at a predetermined start time, and also end the update mode at a predetermined end time.

Further, in this exemplary embodiment, the data distributor 333 distributes update data based on a distribution condition estimated by the distribution condition estimation part 332. However, implementation of the present invention is not limited to the abovementioned case. For example, the data distributor 333 may be configured to distribute update data based on a predetermined distribution rule. Further, the data distributor 333 may be configured to distribute first acquired update data based on the data distribution of the first update data and correct the distribution rule every time acquiring update data. Thus, the data distributor 333 may be configured to execute data distribution based on a rule other than the rule explained above.

### Second Exemplary Embodiment

Next, a second exemplary embodiment of the present invention will be described referring to the attached drawings. In the second exemplary embodiment, a case where a data distributor distributes update data based on a predetermined distribution rule will be described.

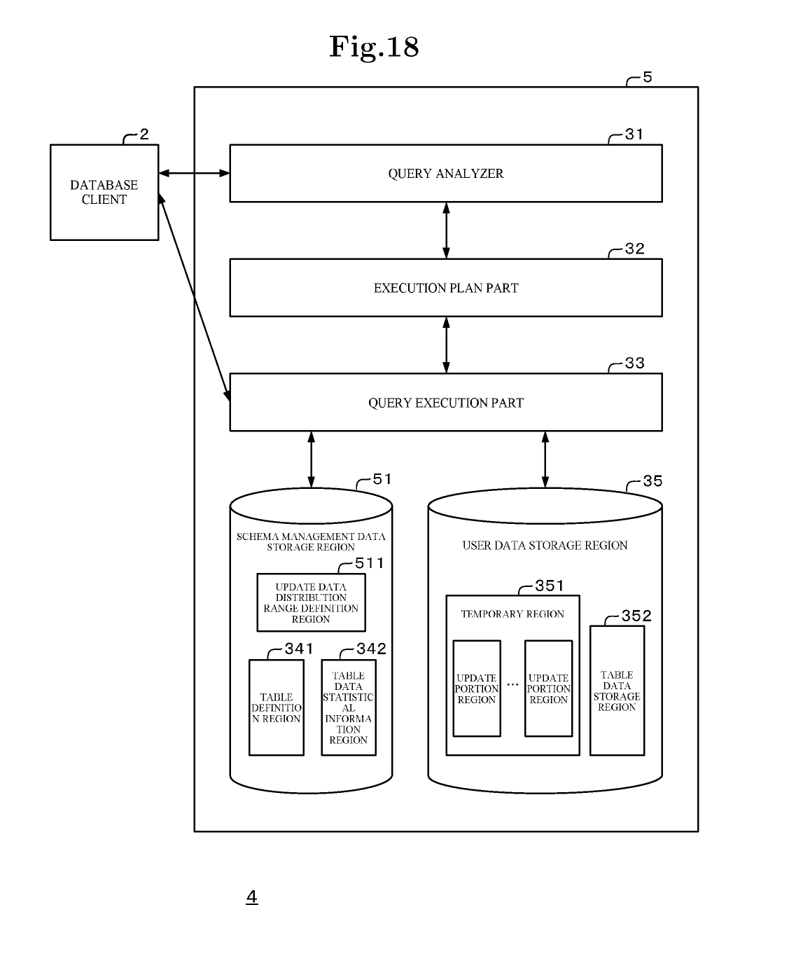

Referring to FIG. 18, a database system 4 in this exemplary embodiment has a database client 2 and a column store database management system 5. Moreover, the column store database management system 5 has a query analyzer 31, an execution plan part 32, a query execution part 33, a schema management data storage region 51, and a user data storage region 35. Moreover, the schema management data storage region 51 has a table definition region 341, a table data statistical information region 342, and an update data distribution range definition region 511. Furthermore, the user data storage region 35 has a temporary region 351 having a plurality of update portion regions 3511, and a table data storage region 352. The same components as in the first exemplary embodiment will be denoted by the same reference numerals.

Thus, the database system 4 of this exemplary embodiment is different from that of the first exemplary embodiment in that the column store database management system 5 has the update data distribution range definition region 511. Moreover, the column store database management system 5 has the same configuration as that of the first exemplary embodiment, except for the update data distribution range definition region 511. In other words, the query execution part 33 also has the functions of the data processor 331, the distribution condition estimation part 332, the data distributor 333, and the update manager 334. Therefore, the update data distribution range definition region 511 that is a component of this exemplary embodiment will be described below.

The update data distribution range definition region 511 stores ranges of data divided for the respective threads with respect to a specific column. In other words, the update data distribution range definition region 511 stores a distribution rule with respect to a specific column. In the case of distributing update data of a specific column, the data distributor 333 distributes the update data based on a distribution rule stored in the update data distribution range definition region 511.

For example, regarding the table shown in FIG. 4, most of the values in End-Of-Sales Date Column of the product table are NULL. In other words, End-Of-Sales Date Column of the product table shown in FIG. 4 represents that most of the products are still being sold. In such a case, it is expected that most of the values supposed to be written in hereafter are more future times than present. On the other hand, the distribution condition estimation part 332 estimates the distribution condition of update data from the present values “NULL,” “2013-2-15,” “2013-6-15” and “2013-8-20.” Therefore, it is highly possible that a distribution condition of update data estimated by the distribution condition estimation part 332 is largely different from an actual distribution condition of update data. In other words, in such a case, it is anticipated that all of the update data concentrate to one thread, and consequently, update performance deteriorates more.

Therefore, regarding a column having such a property, distributing to four ranges “from update date to one month later,” “from one month later to two mounts later,” “from two months later to six months later” and “from then on” is previously defined in the update data distribution range definition region 511. Thus, regarding a column on which data update is supposed to be executed in a largely different manner from the storage condition of the existing database, use of the update data distribution range definition region 511 makes it possible to greatly produce an effect of parallelization of processing.

Thus, the column store database management system 5 of the database system 4 in this exemplary embodiment includes the update data distribution range definition region 511. With this configuration, in a case where data update is supposed to be executed in a largely different manner from the storage condition of the existing database, the data distributor 333 can distribute update data based on the distribution rule stored in the update data distribution range definition region 511. As a result, it becomes possible to make updates by the respective threads uniform, and it becomes possible to greatly produce an effect of parallelization of processing.

### Third Exemplary Embodiment

Next, a third exemplary embodiment of the present invention will be described referring to the attached drawings. In the third exemplary embodiment, the overview of the configuration of a database device 6 which makes a plurality of data processors execute processing in parallel will be described.

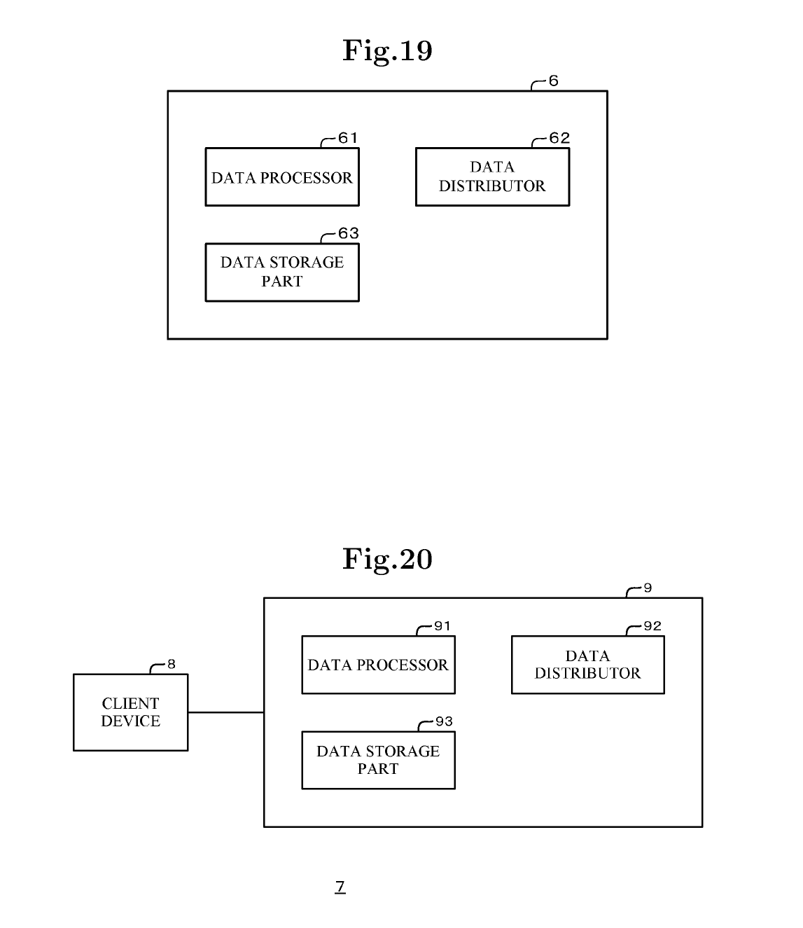

Referring to FIG. 19, the database device 6 in this exemplary embodiment has a data processor 61, a data distributor 62, and a data storage part 63.

The data processor 61 has a function of executing a process of sorting tabular data divided into column forms. As described later, the data processor 61 acquires tabular data from the data distributor 62. Then, the data processor 61 executes the sorting process in accordance with the abovementioned element values contained in the respective records of the tabular data. The database device 6 in this exemplary embodiment has a plurality of data processors 61.

The data distributor 62 has a function of distributing records of acquired tabular data to the data processors 61 in accordance with element values contained in the respective records of the tabular data. The data distributor 62 acquires tabular data from, for example, an external device or an external network. Then, the data distributor 62 distributes the acquired tabular data to the data processors 61 in accordance with element values contained the respective records of the tabular data.

The data storage part 63 is a storage device such as a memory or a hard disk. The data storage part 63 acquires the data divided into column forms and subjected to the abovementioned processing from each of the data processors 61. Then, the data storage part 63 joins and stores the results of the process executed by the respective data processors.

Thus, the database device 6 in this exemplary embodiment has the data processors 61, the data distributor 62, and the data storage part 63. With such a configuration, the data distributor 62 distributes records of tabular data to the data processors 61 in accordance with element values contained in the respective records of the tabular data. The data processors 61 execute parallel processing and thereafter the results of the parallel processing are joined by the data storage part 63. Thus, each of the data processors 61 can execute processing by using data distributed in accordance with element values contained in the respective records of tabular data. In other words, in accordance with element values contained in the respective records of tabular data, data are distributed to the respective data processors 61, and therefore, the data processors can execute highly independent processing, respectively. Consequently, the data processor 61 can proceed processing without waiting processing by the other data processors 61, and can execute data processing while keeping as thread-safe as possible.

The abovementioned database device 6 can be realized by installation of a given program into an information storage device. To be specific, a program as another aspect of the present invention is a program including instructions for causing an information processing device to realize: a plurality of data processors each of which executes a process of sorting tabular data divided into column forms; a data distributor which distributes records of acquired tabular data to the data processors in accordance with element values contained in the respective records of the tabular data; and a data storage part which joins and stores results of the process executed by the respective data processors, wherein the plurality of data processors execute the sorting process in accordance with the element values contained in the respective records of the tabular data.

Further, an information processing method executed by operation of the abovementioned database device 6 includes: distributing records of acquired tabular data to a plurality of data processors in accordance with element values contained in the respective records of the tabular data; causing each of the data processors to execute a process of sorting tabular data divided into column forms; and joining and storing results of the process executed by the respective data processors.

The program and the information processing method having the abovementioned configurations have the same actions as the database device 6, and therefore, can also achieve the abovementioned object of the present invention.

### Fourth Exemplary Embodiment

Next, a fourth exemplary embodiment of the present invention will be described referring to the attached drawings. In the fourth exemplary embodiment, the configuration of a database system 7 which includes a database device 9 causing a plurality of data processors to execute processing in parallel and a client device 8 will be briefly described.

Referring to FIG. 20, the database system 7 in this exemplary embodiment has the client device 8 and the database device 9. Moreover, as shown in FIG. 20, the client device 8 and the database device 9 have a wired connection and are configured to be able to communicate with each other.

The client device 8 has a function of transmitting tabular data to the database device 9.

The database device 9 has a data processor 91, a data distributor 92, and a data storage part 93.

The data processor 91 has a function of executing a process of sorting tabular data divided into column forms. As described later, the data processor 91 acquires tabular data from the data distributor 92. Then, the data processor 91 executes the sorting process in accordance with element values contained in the respective records of the tabular data. The database device 9 in this exemplary embodiment has a plurality of data processors 91.

The data distributor 92 has a function of distributing records of tabular data acquired from the client device 8 to the data processors 61 in accordance with element values contained in the respective records of the tabular data. The data distributor 92 acquires tabular data from the client device 8. Then, the data distributor 92 distributes the acquired tabular data to the data processors 91 in accordance with element values contained in the respective records of the tabular data.

The data storage part 93 is a storage device such as a memory or a hard disk. The data storage part 93 acquires the data divided into column forms and subjected to the abovementioned processing from each of the data processors 91. Then, the data storage part 93 joins and stores results of the processing executed by the respective data processors.

Thus, the database system 7 in this exemplary embodiment has the client device 8 and the database device 9. Moreover, the database device 9 has the data processors 91, the data distributor 92, and the data storage part 93. With such a configuration, the data distributor 92 distributes records of tabular data acquired from the client device 8 to the data processors 91 in accordance with element values contained in the respective records of the tabular data. Then, the data processors 91 execute parallel processing, and thereafter, the data storage part 93 joins the results. Thus, each of the data processors 91 can execute processing by using data distributed in accordance with element values contained in the respective records of tabular data. In other words, in accordance with element values contained in the respective records of tabular data, data are distributed to the respective data processors 91, and therefore, the data processors 91 can execute highly independent processing, respectively. Consequently, the data processor 91 can proceed processing without waiting for processing by the other data processors 91, and can execute processing of data while keeping as thread-safe as possible.

### <Supplementary Notes>

The whole or part of the exemplary embodiments disclosed above may be described as the following supplementary notes. Below, the overview of a database device and so on according to the present invention will be described. However, the present invention is not limited to the following configurations.

### (Supplementary Note 1)

A database device including:

a plurality of data processors each of which executes a process of sorting tabular data divided into column forms;

a data distributor which distributes records of acquired tabular data to the data processors in accordance with element values contained in the respective records of the tabular data; and

a data storage part which joins and stores results of the process executed by the respective data processors,

wherein the plurality of data processors execute the sorting process in accordance with the element values contained in the respective records of the tabular data.

### (Supplementary Note 2)

The database device according to Supplementary Note 1, wherein the data distributor distributes the records of the tabular data to the data processors in accordance with a distribution condition of the element values contained in the respective records of the tabular data.

### (Supplementary Note 3)

The database device according to Supplementary Note 2, wherein the data distributor estimates a distribution condition of the element values contained in the respective records of the tabular data based on a distribution condition of data stored by the data storage part, and distributes the records of the tabular data to the data processors in accordance with the estimated distribution condition of the element values contained in the respective records of the tabular data.

### (Supplementary Note 4)

The database device according to Supplementary Note 2 or 3, wherein the data distributor acquires a distribution condition of the element values contained in the respective records of the tabular data, calculates a distribution threshold equalizing sizes of data distributed to the respective data processors based on the acquired distribution condition of the element values, and distributes the records of the tabular data to the data processors based on the calculated distribution threshold.

### (Supplementary Note 5)

The database device according to any of Supplementary Notes 2 to 4, wherein the data distributor distributes the records of the tabular data to the data processors so that records containing close element values are distributed to a same data processor, in accordance with the distribution condition of the element values contained in the respective records of the tabular data.

### (Supplementary Note 6)

The database device according to any of Supplementary Notes 1 to 5, wherein:

each the data processors combines records of original data previously stored in the data storage part with the records of the acquired tabular data, and executes an update process of the sorting process; and

the data storage part joins and stores results of the update process executed by the respective data processors.

### (Supplementary Note 7)

The database device according to any of Supplementary Notes 1 to 6, including a plurality of data temporary storage parts each of which temporarily stores tabular data, the data temporary storage parts corresponding to the data processors, respectively, wherein:

the data distributor, every time acquiring records of the tabular data, distributes the records of the tabular data to the data temporary storage parts; and

the plurality of data processors start the process on the data stored by the data temporary storage parts at a same time.

### (Supplementary Note 8)

A program including instructions for causing an information processing device to realize:

a plurality of data processors each of which executes a process of sorting tabular data divided into column forms;

a data distributor which distributes records of acquired tabular data to the data processors in accordance with element values contained in the respective records of the tabular data; and

a data storage part which joins and stores results of the process executed by the respective data processors,

wherein the plurality of data processors execute the sorting process in accordance with the element values contained in the respective records of the tabular data.

### (Supplementary Note 9)

An information processing method comprising:

distributing records of acquired tabular data to a plurality of data processors in accordance with element values contained in the respective records of the tabular data; and

causing each of the data processors to execute a process of sorting tabular data divided into column forms, and joining and storing results of the process executed by the respective data processors.

### (Supplementary Note 10)

A database system including a database device and a client device,

the database device including: a plurality of data processors each of which executes a process of sorting tabular data divided into column forms; a data distributor which distributes records of acquired tabular data to the data processors in accordance with element values contained in the respective records of the tabular data; and a data storage part which joins and stores results of the process executed by the respective data processors, wherein the plurality of data processors execute the sorting process in accordance with the element values contained in the respective records of the tabular data, and

the client device transmitting the tabular data to the database device.

The program disclosed in the exemplary embodiments and supplementary note is stored in the storage device, or recorded on a computer-readable recoding medium. For example, the recording medium is a portable medium such as a flexible disk, an optical disk, a magneto-optical disk, or a semiconductor memory.

Although the present invention has been described referring to the exemplary embodiments, the present invention is not limited to the exemplary embodiments described above. The configurations and details of the present invention can be modified and changed in various manners that can be understood by one skilled in the art within the scope of the present invention.

1. A database device comprising:
a plurality of data processors each of which executes a process of sorting tabular data divided into column forms;
a data distributor which distributes records of acquired tabular data to the data processors in accordance with element values contained in the respective records of the tabular data; and
a data storage part which joins and stores results of the process executed by the respective data processors,
wherein the plurality of data processors execute the sorting process in accordance with the element values contained in the respective records of the tabular data.

2. The database device according to claim 1, wherein the data distributor distributes the records of the tabular data to the data processors in accordance with a distribution condition of the element values contained in the respective records of the tabular data.

3. The database device according to claim 2, wherein the data distributor estimates a distribution condition of the element values contained in the respective records of the tabular data based on a distribution condition of data stored by the data storage part, and distributes the records of the tabular data to the data processors in accordance with the estimated distribution condition of the element values contained in the respective records of the tabular data.

4. The database device according to claim 2, wherein the data distributor acquires a distribution condition of the element values contained in the respective records of the tabular data, calculates a distribution threshold equalizing sizes of data distributed to the respective data processors based on the acquired distribution condition of the element values, and distributes the records of the tabular data to the data processors based on the calculated distribution threshold.

5. The database device according to claim 2, wherein the data distributor distributes the records of the tabular data to the data processors so that records containing close element values are distributed to a same data processor, in accordance with the distribution condition of the element values contained in the respective records of the tabular data.

6. The database device according to claim 1, wherein:
each the data processors combines records of original data previously stored in the data storage part with the records of the acquired tabular data, and executes an update process of the sorting process; and
the data storage part joins and stores results of the update process executed by the respective data processors.

7. The database device according to claim 1, comprising a plurality of data temporary storage parts each of which temporarily stores tabular data, the data temporary storage parts corresponding to the data processors, respectively, wherein:
the data distributor, every time acquiring records of the tabular data, distributes the records of the tabular data to the data temporary storage parts; and
the plurality of data processors start the process on the data stored by the data temporary storage parts at a same time.

8. A non-transitory computer-readable medium storing a program comprising instructions for causing an information processing device to realize:
a plurality of data processors each of which executes a process of sorting tabular data divided into column forms;
a data distributor which distributes records of acquired tabular data to the data processors in accordance with element values contained in the respective records of the tabular data; and
a data storage part which joins and stores results of the process executed by the respective data processors,
wherein the plurality of data processors execute the sorting process in accordance with the element values contained in the respective records of the tabular data.

9. An information processing method comprising:
distributing records of acquired tabular data to a plurality of data processors in accordance with element values contained in the respective records of the tabular data; and
causing each of the data processors to execute a process of sorting tabular data divided into column forms, and joining and storing results of the process executed by the respective data processors.

10. A database system comprising a database device and a client device,
the database device including: a plurality of data processors each of which executes a process of sorting tabular data divided into column forms; a data distributor which distributes records of acquired tabular data to the data processors in accordance with element values contained in the respective records of the tabular data; and a data storage part which joins and stores results of the process executed by the respective data processors, wherein the plurality of data processors execute the sorting process in accordance with the element values contained in the respective records of the tabular data, and
the client device transmitting the tabular data to the database device.
